(19) United States
(12) Patent Application Publication
(10) Pub. No.: US 2011/0261645 A1
(43) Pub. Date: Oct. 27, 2011

(54) Non Explosive Process and Device for Triggering an Avalanche

(76) Inventors: David Allen Sager, Phoenix, AZ (US); Gavin Wade Washburn, Phoenix, AZ (US)

(21) Appl. No.: 12/767,167

(22) Filed: Apr. 26, 2010

(51) Int. Cl. G01V 1/00

(52) U.S. Cl. 367/14

(57) ABSTRACT

The invention comprises a synergy of technology integrations including an acoustic device and method of using said device(s)—to initiate avalanche release as a non-explosive control alternative. The invention is an integration of technologies incorporating an acoustic device, power supply and amplification, inverter, digital signal processor, GPS, and RF receiver all housed in a rugged weather resistant enclosure with necessary gantry and rigging. The combination of these technologies allows control personnel to safely operate the equipment from a remote location. The invention is deployed remotely via a cable or network of cables to predetermined avalanche starting zone(s). The device can be rotated, panned the full length or range of the cable(s), and tilted offering the user comprehensive coverage of any topography. The invention can readily be integrated with equipment and infrastructures already in use such as bomb trams, cable and pylon networks, helicopters, chairlifts, and sensing and notification systems.

### FIELD OF THE INVENTION

The subject invention concerns a method of initiating an avalanche in which a non-explosive triggering device; an electric acoustic device, is deployed into a predetermined avalanche zone or zones in which the avalanche is to be initiated.

A device is also described for the use of this method to initiate an avalanche, including means of generating resonance that overcomes the attenuation of the snowpack in a predetermined zone or zones in which the avalanche is to be set.

### BACKGROUND OF THE INVENTION

This invention relates to an electronic device able to produce high amplitudes and low frequency longitudinal waves with sufficient intensity to overcome the attenuation properties of a snowpack, thus creating a geometrical resonance in the snowpack's framework, ultimately collapsing the weak layer, and here by initiating an avalanche.

Avalanches can present serious dangers to persons and or property when triggered in an uncontrolled manner, whether by natural causes such as weather conditions or unintentionally as a result of human activity such a skiing or hiking. Therefore the continuous maintenance of avalanche control programs worldwide has become well established.

Control techniques can be divided into two main categories; passive and active. Two examples of passive techniques include the construction of terraced barriers on the mountain slopes designed to pin the snow layers thus preventing slippage and the construction of snow dams at the base of the slope intended to divert avalanche run outs from structures considered to be at risk. Active techniques such as launching artillery from Howitzers or Avalaunchers, placing explosives by hand, hell-bombing, and cross cut skiing are all common practices carefully coordinated with weather system surveillance, local condition forecasting, infrasonic sensing, and notification systems all designed induce controlled artificial avalanche releases.

The practice of regularly triggering small, controlled releases is intended to minimize the buildup of snow in known starting zones which, if left uncontrolled would eventually release naturally. Such natural releases of large volumes of snow can accumulate into massive slides ultimately causing extensive damage to services, infrastructures, a variety of property and people. Every year approximately 30 people are killed by avalanches, worldwide.

This invention supports active methods of avalanche control and in particular is intended to replace all explosive practices currently in use today. Currently the safest explosive method is known as Gaz-Ex in which a large divergent tube is constructed in known starting zones and is aimed downward toward the snowpack. A mixture of oxygen and propane is ignited inside the tube by a remote management system. The resulting shockwave from the explosion above the snow surface stimulates a controlled release of the snowpack. It is well documented that an explosion or overpressure just a few feet above the snow surface is the most effective method of avalanche initiation.

There have been substantial advancements in pyrotechnic delay fuse technology and the designing of shaped charges to increase the effectiveness of the explosive charges and increase the safety for control personnel. Widely in use today in alpine countries in Europe are Wyssen towers and Doppelmayr bomb trams. These systems of pylons and cable networks deploy explosives into inaccessible regions and allow for safe remote and or timed delay fuse detonation of explosives over predetermined starting zones. Regardless of newer, more effective, and safer developments however the industry is still in danger of untimely detonations and subject to rigorous transportation, storage, and handling procedures enforced by the United States Army and Homeland security.

The use of explosives of any kind presents inherent dangers to control personnel regardless of the strict protocols in place to hedge these dangers. In recent years some national parks have already banned the use of explosives. Transportation entities for example, BNSF Railroad have been forced to spend millions rebuilding snow sheds, tunnels, and bridges damaged by wildfires to protect their transportation routes due to the banning of explosives in Glacier National Park. In the avalanche community it is unanimous that a satisfactory alternative be identified sooner than later.

Compounding the known dangers of explosives use the United States Geological Survey (USGS) has conducted surveys in the Wasatch Mountains of Utah where explosives are used for avalanche control to determine the concentration of explosive compounds in snow, soil, and lake-bottom sediment. While the Unites States Environmental Protection Agency (USEPA) has set health advisories for four of the explosive-residue compounds found in snow samples it is not a legally enforceable standard.

The USGS and USEPA use two benchmarks to measure the cancer risk threshold: (1) 10⁻⁴ cancer risk, which is the concentration of a chemical in drinking water corresponding to an estimated cancer risk of 1 in 10,000; and (2) HA, which is the concentration of a chemical in drinking water that is not expected to cause any adverse noncarcinogenic effects for a lifetime of exposure. Up to seven explosive compounds were found to be present in the samples tested although all compounds were found to be in quantities under the above mentioned safety thresholds. None the less these studies are raising the eyebrows of many that live, work, and play in and near these wilderness areas.

### SUMMARY OF THE INVENTION

The present invention offers a solution to all of the above mentioned disadvantages and describes a method to initiate avalanches in any and all topographies considered to be avalanche control areas.

One example of a configuration of the invention comprises a pair of infrasonic generators positioned contiguously with one another with the aperture of each facing downward. The generators are contained in a suitable housing which additionally holds all electronic components; power supplies, inverter, amplifiers, digital signal processor, and an RF receiver. The apertures are where the longitudinal/compression waves are released into the environment. One example of a pan and tilt and fully rotatable housing and gantry system described below allows for the “aiming” of these compression waves.

Opposing ends of the housing for example could be provided with slave gears to be met with a pair of powered gears at either end of the housing's balanced pivot point or Y-axis. For example a gantry is equipped to either side of the pivot points providing a fixed position for a pair of electric motors fitted with their respective drive gears to tilt the device around the Y-axis. A lower gantry could be constructed to allow the housing to tilt around the Y-axis. Either side of the gantry would meet above the housing at the balanced center or Z-axis and be equipped with a slave gear to be met with its respective drive gear for example. A median gantry might have a fixed electric motor fitted with a drive gear to drive the slave gear on the top of a lower gantry, thus rotating the device around the Z-axis. Fixed to the median gantry could be a winch(s) equipped with a length of cable(s) that ascend to an upper gantry or other configuration to prevent uncontrolled spinning while allowing the operator to raise and lower the equipment along the Z-axis. A set of pulleys equipped with small electric motor(s) for example could allow the deployment of the device along any length of cable or cables.

The compression waves propagated by the generators are of sufficient intensity they can overcome the attenuation properties of the snow. The waves penetrate the snowpack layers causing a forced harmonics and or a sympathetic resonance within the snowpack framework causing the geometry to vibrate and collapse. With this collapse the snow can no longer support its own weight and being subject to gravity the avalanche is initiated.

The invention is deployed into predetermined starting zones manually or automatically with an RF remote by a control operator. The apertures of the acoustic devices can be positioned to any height above the snow surface and aimed in any manner deemed necessary by the operator. The present invention allows unparalleled control of the pressure waves with limitless proximity potentials. The invention boasts far reaching signal processing capabilities allowing the operator in real time to focus or oscillate through a range of frequencies, vary the frequency modulation and intervals, and position the equipment almost anywhere in three dimensional space. Currently there is not a solution in the industry that can come close to offering the range of options and potentials the present invention offers. Additionally, the present invention is non-explosive and is environmentally neutral.

Additionally this invention can be integrated with numerous technologies already in place and or in existence. For example, the present invention can be integrated with existing bomb trams, GPS systems for exacting deployment, on board power supply, inverter, video, and sensing systems, digital signal processing equipment, notification and sensing software programs and computer platforms, robust remote technologies for manual and autonomous operations, as well as elaborate reeving technologies used typically to navigate cameras anywhere in a three dimensional space at stadiums and live events.

Avalanche control happens to be only one market the present invention can be used for. For example this system can be used to eradicate bark beetles from forested areas. With digital signal processing and the implementation of forced harmonics and or sympathetic resonance and the appropriate frequency amplitude and modulation the beetles could no longer find their present residence livable.

In another example the invention can be used in agricultural areas for the elimination of nuisance rodents, birds, and even insects from a given area. Extremely low frequency pulses can be generated below human hearing levels while making the “treated” area a haven for thriving plants and a dead zone for unwanted animals and insects.

To protect animal trainers and animal handlers this invention can be used to alert or “communicate” with the animal(s) in turn protecting humans from a would be assault or even death due to an attack.

While the subject invention can be deployed on land it could also be used in under-sea applications. Using the appropriate frequencies in conjunction with proper placement of the apparatus whales will no longer beach themselves and sharks could be prevented from entering waters where people like to enjoy surfing, swimming, and the like.

Furthermore, the present invention can be used for calibrating seismic sensing equipment that is commonly used in mining, nuclear testing, and avalanche mitigation.

Still another example where the invention might be used is at large stadiums and or live performance venues where low frequency and high modulation of a digital signal(s) is desired to round out the overall sonic experience for the listener.

In another example this invention could even be used for crowd control. Extremely low frequencies combined with very high sound pressure levels can deter would be attacker(s) from approaching beyond a certain point for instance.

The present invention can be used to power heating and cooling systems rough a process known as thermo-acoustic generation.

### BRIEF DESCRIPTION OF THE DRAWINGS

FIG. 1

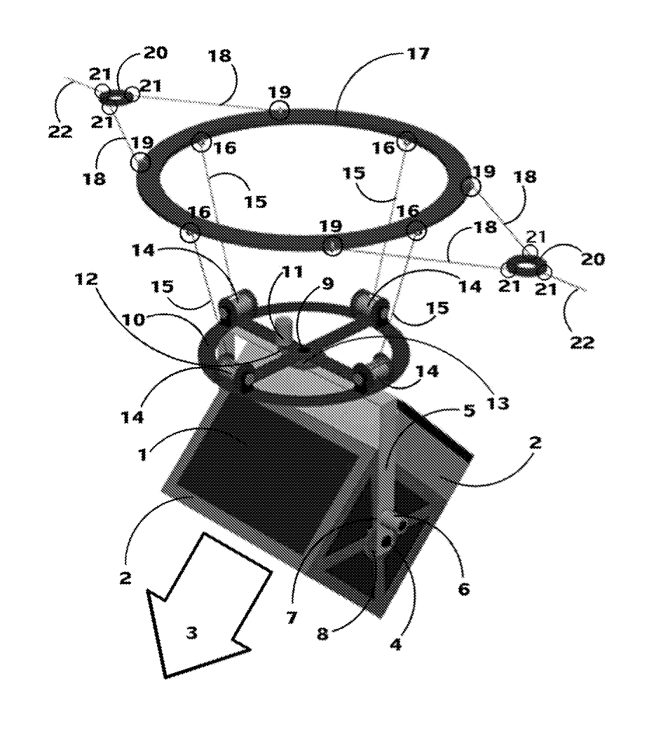

This drawing shows one example of the invention as it might be configured to be used or avalanche control work.

### DETAILED DESCRIPTION OF THE PREFERRED EMBODIMENT

With reference to the FIGURE, the apparatus comprises an acoustic device 1 inside a suitable housing 2 so as to allow the sound generated by the acoustic device 1 to enter the environment unrestricted 3. In the present case the housing 2 is pivoted 4 by means of a lower gantry system 5. To either side of the lower gantry 5 in this FIGURE are electric motors 6 each fitted with a drive gear 7 that turns a slave gear 8 which rotates the acoustic device 1 and housing 2 around an axis.

Attached at an appropriate pivot point 9 of the lower gantry 5 is a upper gantry 10 equipped with an electric motor 11 provided with a drive gear 12 which turns the lower gantry's slave gear 13 that rotates the lower gantry 5, acoustic device 1, and housing 2 around an axis 9.

Also in this FIGURE, mounted to the upper gantry 10 is a network of winches 14 each equipped with a length of cable 15 and hooking apparatuses 16 which attach the above described embodiment to a system stabilization component 17 that is appropriately supported by a number of stabilizing cables 18 by means of hooking apparatuses 19. The stabilizing cables 18 from either side of the stabilization component 17 converge to a buckle 20 and are attached again by means of hooking apparatuses 21. Opposite the stabilizing cables 18 extending from both of the buckles 20 is a length of cable 22 attached to the buckle 20 with appropriate hooking components 21.

The apparatus described above by way of an example of the invention can obviously undergo numerous modifications and or variations. For example, a single length of cable 22 could be descended by a length of cable 15 that might correspond to a single winch 14 assembly for raising and lowering the above described configuration. The entire gantry system could in fact be abandoned for a more cost conscious and streamline deployment where topography might permit.

The embodiments of the invention in which an exclusive property or privilege is claimed are defined as follows:

1. An electronic acoustic device used to generate acoustic waves with sufficient pressure to initiate avalanches
(a) An acoustic device capable of generating high amplitude longitudinal waves;
(b) An on board digital signal processor, RF receiver, power supply, and inverter;
(c) A housing and gantry system to protect and maneuver the acoustic device and on board electronic equipment;
(d) An apparatus to deploy and position the system into a predetermined area;
(e) A computer or other user interface to operate the electronic equipment wherein digital signals recorded or in real time are transmitted by radio frequency to the digital signal processor that is in electrical communication with the acoustic device.

2. The device of claim 1, wherein internal transducers and wave guide construction of the acoustic device are capable of outputting highly modulated frequencies while producing extremely high amplitude low frequency longitudinal compression waves of sufficient sound pressure levels to initiate avalanches

3. The device of claim 1, wherein an onboard digital signal processor, receiver, power supply, and inverter are configured to communicate input signals electronically to the acoustic device

4. The device of claim 1, further comprising a housing to protect the on board electronic equipment while the gantry allows an operator to meticulously maneuver the device in the predetermined area from a remote location

5. The device of claim 1, wherein a simple or elaborate system of motors and cables are arranged to deploy the device into a predetermined location of any avalanche control area

6. The device of claim 1, further comprising a computer or other user interface allows an operator to transmit digital signals recorded or in real time by radio frequency to the on board receiver and signal processing equipment that is in calibrated electronic communication with the electronic acoustic device.

7. A method of using an electronic acoustic device to generate compression waves of sufficient power to initiate an avalanche.
(a) Deployment of an electronic acoustic device into a predetermined location with the appropriate rigging apparatus configured to accommodate a given topography;
(b) Positioning and operating an electronic acoustic device in a predetermined area from a remote location by way of suitable gantry and rigging components, power supply, calibrated signal processing, and advanced remote technologies;
(c) Composing and inputting digital signals to an electronic acoustic device either by way of software, computer(s) and or digital signal processing so the output from the acoustic device will create geometrical resonance in the snowpack's framework, ultimately collapsing the weak layer, and here by initiating the avalanche;
(d) Incorporating existing sensing and notification systems to autonomously deploy, process, and operate all functions of the invention.

8. The method of claim 7, wherein the use of an electronic acoustic device comprises either a fixed mount or a network of cables and motors configured to deploy and position an acoustic device into a predetermined location within adequate proximity of a snowpack to cause an avalanche.

9. The method of claim 7, wherein the use of an electronic acoustic device is configured with a housing to protect all on board electronic equipment and a suitable gantry and rigging to allow an operator to have a full range of maneuverability; to pan, tilt, rotate, ascend, and descend the acoustic device in any predetermined location to accommodate all topography characteristics.

10. The method of claim 7, wherein the use of an electronic acoustic device further comprising: the input of digital signals from a computer or other user interface that is transmitted by radio frequency to the calibrated on board receiver and signal processor that are in communication with the acoustic device. The input signals must contain the appropriate frequency interval and modulation information to produce compression waves that will resonate with a given snow pack.

11. The method of claim 7, wherein the use of an electronic acoustic device is integrated with existing sensing and notification systems to allow autonomous deployment, processing, and operation of all the system's functions.
